(19) United States
(12) Patent Application Publication
(10) Pub. No.: US 2022/0053593 A1
(43) Pub. Date: Feb. 17, 2022

(54) Fast Discontinuous Reception (DRX) Cycle Adjustment

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/275,823

(22) PCT Filed: Oct. 1, 2019
(86) PCT No.: PCT/US2019/054119

§ 371 Date: Mar. 12, 2021

Related U.S. Application Data
(60) Provisional application No. 62/741,271, filed on Oct. 4, 2018.

(51) Int. Cl. H04W 76/28; H04W 52/02; H04W 74/08

(52) U.S. Cl. CPC H04W 76/28; H04W 52/0216; H04W 52/0277; H04W 74/0833; H04W 52/0225

(57) ABSTRACT

This document describes techniques that enable fast discontinuous reception (DRX) cycle adjustment. Using the described techniques, a user equipment can detect trigger events that indicate the user equipment may be in a state that can be mitigated by a DRX cycle configuration adjustment. In response to the trigger event, the user equipment can generate an instant DRX change request (IDCR). The user equipment can transmit the IDCR to a base station that is providing a current DRX cycle configuration and direct the base station to provide an adjusted DRX cycle configuration that is based at least in part on the IDCR. These techniques allow the user equipment to adjust the DRX cycle configuration when the user equipment is in a radio resource control (RRC)-inactive mode or an RRC-idle mode, which can enable the user equipment to quickly mitigate operating conditions such as low battery capacity.

### BACKGROUND

The evolution of wireless communication to fifth generation (5G) standards and technologies provides higher data rates and greater capacity, with improved reliability and lower latency, which enhances mobile broadband services. 5G technologies also provide new classes of services for vehicular networking, fixed wireless broadband, and the Internet-of-Things (IoT).

A unified air interface, which utilizes licensed, unlicensed, and shared license radio spectrum in multiple frequency bands, is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband. Another aspect of enabling the capabilities of 5G systems is the use of Multiple Input Multiple Output (MIMO) antenna systems to beamform signals transmitted between base stations and user equipment to increase the capacity of 5G radio networks.

5G networks enable higher data-transfer rates, compared to existing networks. These higher data rates may cause the user equipment to operate at higher temperatures and consume more power relative to operation on conventional networks. Some conventional techniques for managing power consumption of the user equipment may rely on techniques such as discontinuous reception (DRX) to reduce power consumption by periodically turning some user equipment components off for a short duration and then turning them back on to check for incoming data transmissions. In some cases, however, especially when the length of the off duration is shorter, the power used to turn components back on and operate them can be significant, leading to critical power-management issues.

### SUMMARY

This document describes techniques and systems that enable fast discontinuous reception (DRX) cycle adjustment. The techniques and systems use an instant DRX change request (IDCR) to adjust a DRX cycle configuration that is provided to a user equipment by a base station. The user equipment can detect trigger events that can indicate the user equipment may be in a state that can be mitigated by a DRX cycle configuration adjustment. The user equipment can transmit the IDCR to the base station using a Random Access Channel (RACH) sequence or a Physical Random Access Channel (PRACH) sequence. These techniques allow the user equipment to adjust the DRX cycle configuration even when the user equipment is in a disengaged mode, such as a radio resource control (RRC)-inactive mode or an RRC-idle mode (and without waiting for an uplink grant), which can enable the user equipment to quickly mitigate adverse operating conditions, such as low battery capacity or excessive temperature.

In some aspects, a method for adjusting a current discontinuous reception (DRX) cycle configuration for a user equipment (UE) is described. The method comprises detecting, by the UE, a trigger event and, in response to detecting the trigger event, determining an instant DRX change request (IDCR). The method further includes the UE transmitting, while the UE is in a disengaged mode, the IDCR to a base station that is providing the current DRX cycle configuration, the transmitting effective to direct the base station to provide an adjusted DRX cycle configuration that is based at least in part on the IDCR.

In other aspects, a method for adjusting a discontinuous reception (DRX) cycle configuration for a user equipment (UE) is described. The method comprises the UE entering a disengaged mode and negotiating a DRX cycle configuration adjustment schedule with a base station that is providing the DRX cycle configuration. The negotiating occurs while the UE is in the disengaged mode. The method further comprises receiving, from the base station, an acknowledgement of the negotiated DRX cycle configuration adjustment schedule. The method also includes, in response to the acknowledgement, operating, by the UE, with an adjusted DRX cycle configuration that is based at least in part on the DRX cycle configuration adjustment schedule.

In further aspects, a user equipment (UE) is described that includes a radio frequency (RF) transceiver and a processor and memory system configured to perform the described methods.

In further aspects, a user equipment (UE) is described that includes a radio frequency (RF) transceiver and a processor and memory system to implement a means for detecting a trigger event and, in response to detecting the trigger event, generating a request to change a current discontinuous reception (DRX) cycle configuration that the UE is operating under. Further, the UE can transmit, using the RF transceiver and while the UE is in a disengaged mode, the request to change the current DRX cycle configuration to a base station that is providing the current DRX cycle configuration. The UE also includes a means to receive, from the base station, an adjusted DRX cycle configuration that is based, at least in part, on the request to change the current DRX cycle configuration and direct the UE to operate under the adjusted DRX cycle configuration.

This summary is provided to introduce simplified concepts of fast DRX cycle adjustment. The simplified concepts are further described below in the Detailed Description. This summary is not intended to identify essential features of the claimed subject matter, nor is it intended for use in determining the scope of the claimed subject matter.

### BRIEF DESCRIPTION OF THE DRAWINGS

Aspects of fast DRX cycle adjustment are described with reference to the following drawings. The same numbers are used throughout the drawings to reference like features and components:

FIG. 1 illustrates an example environment in which various aspects of fast DRX cycle adjustment can be implemented.

FIG. 2 illustrates an example device diagram that can implement various aspects of fast DRX cycle adjustment.

FIG. 3 illustrates example user equipment states which may benefit from aspects of fast DRX cycle adjustment.

FIG. 4 illustrates an air interface resource that extends between a user equipment and a base station and with which various aspects of fast DRX cycle adjustment can be implemented.

FIG. 5 illustrates an example method for fast DRX cycle adjustment as generally related to adjusting a current DRX cycle configuration, negotiated between a user equipment and a base station, in accordance with aspects of the techniques described herein.

FIG. 6 illustrates another example method for fast DRX cycle adjustment as generally related to adjusting a current DRX cycle configuration, negotiated between a user equipment and a base station, in accordance with aspects of the techniques described herein.

### DETAILED DESCRIPTION

Overview

This document describes techniques using, and devices enabling, fast discontinuous reception (DRX) cycle adjustment. As noted, fifth-generation new radio (5G NR) networks enable larger amounts of data to be transferred at higher data rates, as compared to existing wireless networks. The higher data rate may cause the user equipment to operate at higher temperatures and consume more power relative to operation on conventional networks. The user equipment may use techniques such as conventional DRX to reduce power consumption by periodically turning some user equipment components off for a short duration (e.g., a sleep duration) and then turning them back on (e.g., a wake duration) to check for incoming data transmissions. These conventional techniques, however, even in cases when the user equipment is in a disengaged mode (e.g., a radio resource control (RRC)-inactive or RRC-idle mode, as described below), can still use significant amounts of power to turn on and operate these components. This unnecessary power consumption can lead to critical power management issues. Further, conventional DRX techniques may lead to situations in which the user equipment is allocated unneeded network resources that could be allocated to other user equipment.

In contrast, the described techniques allow a user equipment to send an instant DRX change request (IDCR) to a base station while the user equipment is in the disengaged mode (e.g., the RRC-inactive or RRC-idle mode, as noted above). Based on the IDCR, the base station adjusts a DRX cycle configuration that is provided to the user equipment by the base station (e.g., by increasing the length of the sleep duration). The user equipment may send the IDCR to the base station in response to a trigger event, such as a battery-capacity threshold or a thermal parameter threshold. The IDCR can be transmitted to the base station using a variety of lower layer connections, including a Random Access Channel (RACH) sequence or a Physical Random Access Channel (PRACH) sequence, which allow the IDCR to be transmitted while the user equipment is in the disengaged mode and/or without an uplink grant. Thus, the user equipment can take advantage of the IDCR to dynamically change the DRX cycle configuration under which it is operating. In this way, the user equipment can address thermal and battery-capacity challenges while in the disengaged mode and without adversely affecting network resource utilization efficiency or consuming unneeded network resources that can be used by other devices on the network.

Consider, for example, a user equipment that has a low remaining battery-capacity level and is operating in the RRC-inactive mode. As the user equipment continues to operate in the RRC-inactive mode, the battery continues to consume power. Using conventional techniques, such as a conventional DRX mode in which the user equipment periodically enters a lower-power mode (e.g., the sleep duration) to save power, the user equipment may still run out of power, experience battery failure (e.g., if the battery overheats), or suffer other damage caused by excess heat. In contrast, using the described techniques, the user equipment can transmit the IDCR to the base station and adjust the DRX cycle configuration to enable a longer sleep duration while the user equipment remains in the RRC-inactive mode (or the RRC-idle mode) and without waiting for an uplink grant. This can preserve battery capacity and allow the user equipment to operate longer.

While features and concepts of the described systems and methods for fast DRX cycle adjustment can be implemented in any number of different environments, systems, devices, and/or various configurations, aspects of fast DRX cycle adjustment are described in the context of the following example devices, systems, and configurations.

Example Environment

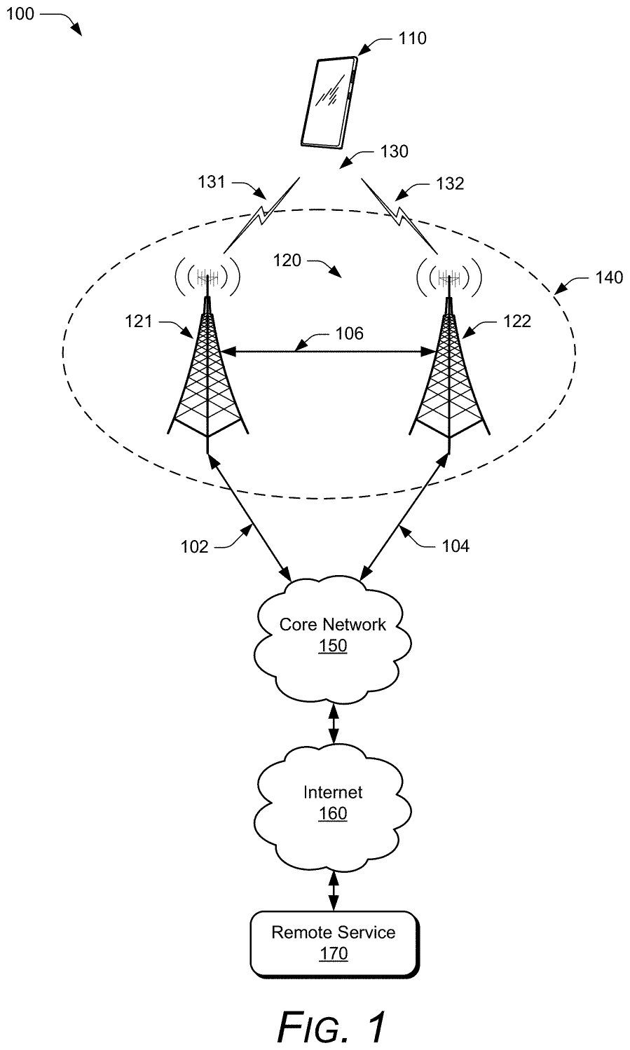

FIG. 1 illustrates an example environment 100, which includes a user equipment 110 (UE 110) that can communicate with base stations 120 (illustrated as base stations 121 and 122) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, and the like, or any combination thereof.

The base stations 120 communicate with the user equipment 110 using the wireless links 131 and 132, which may be implemented as any suitable type of wireless link. The wireless links 131 and 132 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an Si interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at 106, to exchange user-plane and control-plane data. The user equipment 110 may connect, using the core network 150, to public networks, such as the Internet 160 to interact with a remote service 170.

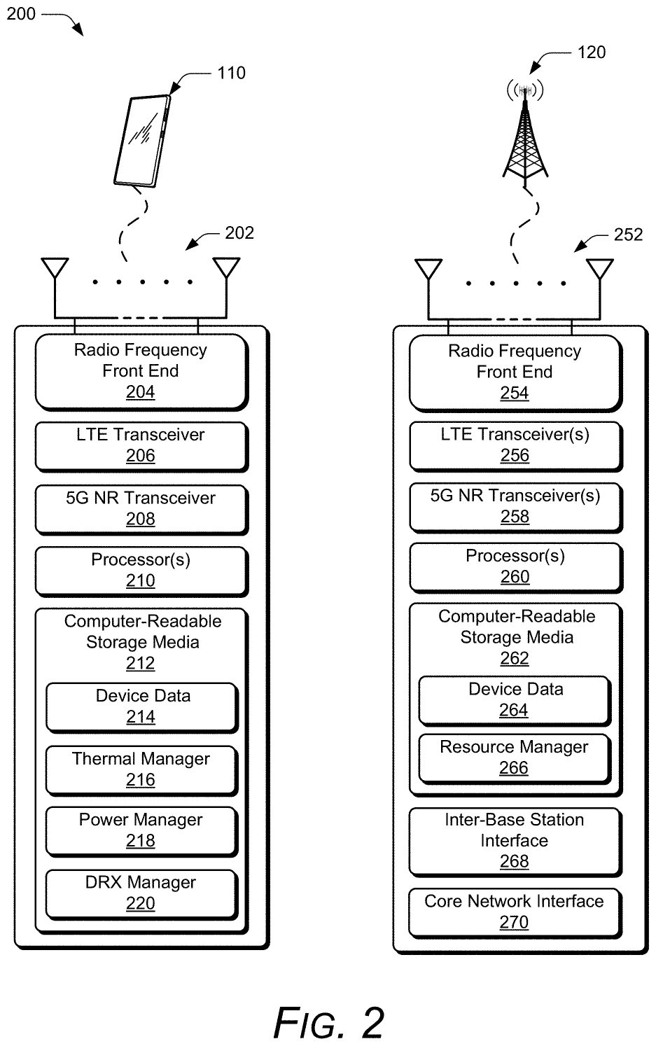

FIG. 2 illustrates an example device diagram 200 of the user equipment 110 and the base stations 120. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, and a 5G NR transceiver 208 for communicating with base stations 120 in the RAN 140. The RF front end 204 of the user equipment 110 can couple or connect the LTE transceiver 206, and the 5G NR transceiver 208 to the antennas 202 to facilitate various types of wireless communication. The antennas 202 of the user equipment 110 may include an array of multiple antennas that are configured similarly to, or differently from, each other. The antennas 202 and the RF front end 204 can be tuned to, and/or be tunable to, one or more frequency bands defined by the 3GPP LTE and 5G NR communication standards and implemented by the LTE transceiver 206, and/or the 5GNR transceiver 208. Additionally, the antennas 202, the RF front end 204, the LTE transceiver 206, and/or the 5GNR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards.

The user equipment 110 also includes processor(s) 210 and computer-readable storage media 212 (CRM 212). The processor 210 may be a single-core processor or a multiple-core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the user equipment 110. The device data 214 includes user data, multimedia data, beamforming codebooks, applications, and/or an operating system of the user equipment 110, which are executable by processor(s) 210 to enable user-plane communication, control-plane signaling, and user interaction with the user equipment 110.

In some implementations, the CRM 212 may also include either or both of a thermal manager 216 and a power manager 218. The thermal manager 216 can communicate with one or more thermal sensors (e.g., a thermistor or other temperature or heat sensor), in or associated with the user equipment 110, which measure temperature and other thermal properties of the user equipment 110 (including individual measurements of various components of the user equipment 110). The thermal manager 216 can store and transmit values of the measurements to other components of the user equipment 110 or to other devices.

The power manager 218 can monitor a battery (or batteries) of the user equipment 110. The power manager 218 can also measure, store, and communicate values of various power-related parameters of the user equipment 110 (e.g., remaining battery capacity) to other components of the user equipment 110 or to other devices. Further, while both are shown as part of the CRM 212 in FIG. 2, either or both of the thermal manager 216 and the power manager 218 may be implemented in whole or part as hardware logic or circuitry integrated with or separate from other components of the user equipment 110.

CRM 212 also includes a DRX manager 220. Alternatively or additionally, the DRX manager 220 may be implemented in whole or part as hardware logic or circuitry integrated with or separate from other components of the user equipment 110. In at least some aspects, the DRX manager 220 configures the RF front end 204, the LTE transceiver 206, and/or the 5G NR transceiver 208 to implement the techniques for fast DRX cycle adjustment described herein.

For example, the DRX manager 220 may negotiate with the base stations 120 (e.g., with the base station 121) to determine a DRX cycle configuration and then direct the user equipment 110 to operate under the negotiated DRX cycle configuration. The DRX manager 220 can also detect a trigger event and, in response to the trigger event, generate an instant DRX change request (IDCR) that includes a requested change to the DRX cycle configuration (the DRX cycle configuration is described with additional detail below). In some cases, the DRX manager 220 may detect the trigger event by communicating with either or both of the thermal manager 216 and the power manager 218. Further, the DRX manager 220 may also transmit the IDCR to the base stations 120 and direct the user equipment 110 to operate under an adjusted DRX cycle configuration that is provided by the base stations 120 and based at least in part on the IDCR. In some implementations, the IDCR may also include a request to change other DRX-related parameters, such as a physical downlink control channel (PDCCH) bandwidth or a radio resource management (RRM) measurement bandwidth.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the user equipment 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similarly to, or differently from, each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the user equipment 110.

The base stations 120 also include processor(s) 260 and computer-readable storage media 262 (CRM 262). The processor 260 may be a single-core processor or a multiple-core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The CRM 262 may exclude propagating signals. The device data 264 includes network scheduling data, radio resource management data, beamforming codebooks, applications, and/or an operating system of the base stations 120, which are executable by processor(s) 260 to enable communication with the user equipment 110.

CRM 262 also includes a resource manager 266. Alternatively or additionally, the resource manager 266 may be implemented in whole or part as hardware logic or circuitry integrated with or separate from other components of the base stations 120. In at least some aspects, the resource manager 266 configures the LTE transceivers 256 and the 5G NR transceivers 258 for communication with the user equipment 110, as well as communication with a core network, such as the core network 150. Additionally, the resource manager 266 may negotiate with the user equipment 110 to determine a DRX cycle configuration that the base stations 120 provide to the user equipment 110. The resource manager 266 may also receive the IDCR from the user equipment 110. Based at least in part on the IDCR, the resource manager 266 may determine an adjusted DRX cycle configuration and provide the adjusted DRX cycle configuration to the user equipment 110. Additionally or alternatively, the base stations 120 may determine, based on the IDCR, adjustments to other DRX-related parameters, such as the PDCCH bandwidth or an RRM measurement bandwidth.

The base stations 120 include an inter-base station interface 268, such as an Xn and/or X2 interface, which the resource manager 266 configures to exchange user-plane and control-plane data between other base stations 120, to manage the communication of the base stations 120 with the user equipment 110. The base stations 120 include a core network interface 270 that the resource manager 266 configures to exchange user-plane and control-plane data with core network functions and entities.

User Equipment States and Air Interface Resources

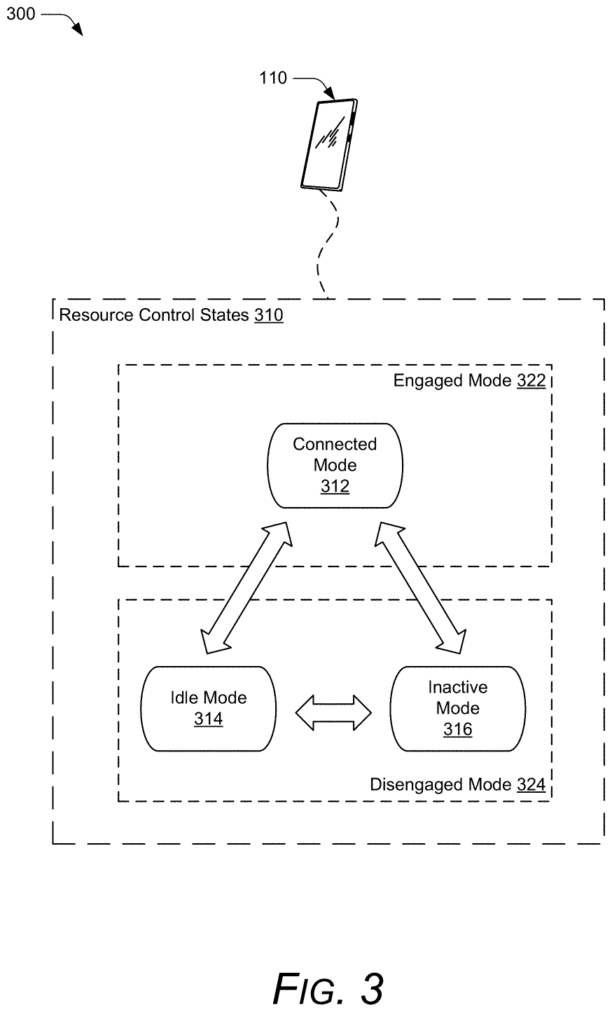

FIG. 3 illustrates example user equipment states 300, which may benefit from aspects of fast DRX cycle adjustment, as described herein. Generally, a wireless network operator provides its telecommunication services to user equipment through a wireless network. To communicate wirelessly with the network, a user equipment 110 utilizes a radio resource control (RRC) procedure to establish a connection to the network using a cell (e.g., the base station, a serving cell). Upon establishing the connection to the network using the base stations 120, the user equipment 110 enters a connected mode (e.g., RRC-connected mode, RRC_CONNECTED state, NR-RRC CONNECTED state, or E-UTRA RRC CONNECTED state).

The user equipment 110 operates according to different resource control states 310. Different situations may occur that cause the user equipment 110 to transition between different resource control states 310 as determined by the radio access technology. Example resource control states 310 illustrated in FIG. 3 include a connected mode 312, an idle mode 314, and an inactive mode 316. A user equipment 110 is either in the connected mode 312 or in the inactive mode 316 when an RRC connection is active. If an RRC connection is not active, then the user equipment 110 is in the idle mode 314.

In establishing the RRC connection, the user equipment 110 may transition from the idle mode 314 to the connected mode 312. After establishing the connection, the user equipment 110 may transition (e.g., upon connection inactivation) from the connected mode 312 to an inactive mode 316 (e.g., RRC-inactive mode, RRC_INACTIVE state, NR-RRC INACTIVE state) and the user equipment 110 may transition (e.g., using an RRC connection resume procedure) from the inactive mode 316 to the connected mode 312. After establishing the connection, the user equipment 110 may transition between the connected mode 312 to an idle mode 314 (e.g., RRC-idle mode, RRC_IDLE state, NR-RRC IDLE state, E-UTRA RRC IDLE state), for instance upon the network releasing the RRC connection. Further, the user equipment 110 may transition between the inactive mode 316 and the idle mode 314.

Further, the user equipment 110 may be in an engaged mode 322 or may be in a disengaged mode 324. As used herein, an engaged mode 322 is a connected mode (e.g., connected mode 312) and a disengaged mode 324 is an idle, disconnected, connected-but-inactive, connected-but-dormant mode (e.g., idle mode 314, inactive mode 316). In some cases, in the disengaged mode 324, the user equipment 110 may still be registered at a Non-Access Stratum (NAS) layer with radio bearer active (e.g., inactive mode 316).

Each of the different resource control states 310 may have different quantities or types of resources available, which may affect power consumption within the user equipment 110. In general, the connected mode 312 represents the user equipment 110 actively connected to (engaged with) the base stations 120. In the inactive mode 316, the user equipment 110 suspends connectivity with the base station 120 and retains information that enables connectivity with the base station 120 to be quickly re-established. In the idle mode 314, the user equipment 110 releases the connection with the base stations 120.

Some of the resource control states 310 may be limited to certain radio access technologies. For example, the inactive mode 316 may be supported in LTE Release 15 (eLTE) and 5G NR, but not in 3G or previous generations of 4G standards. Other resource control states may be common or compatible across multiple radio access technologies, such as the connected mode 312 or the idle mode 314.

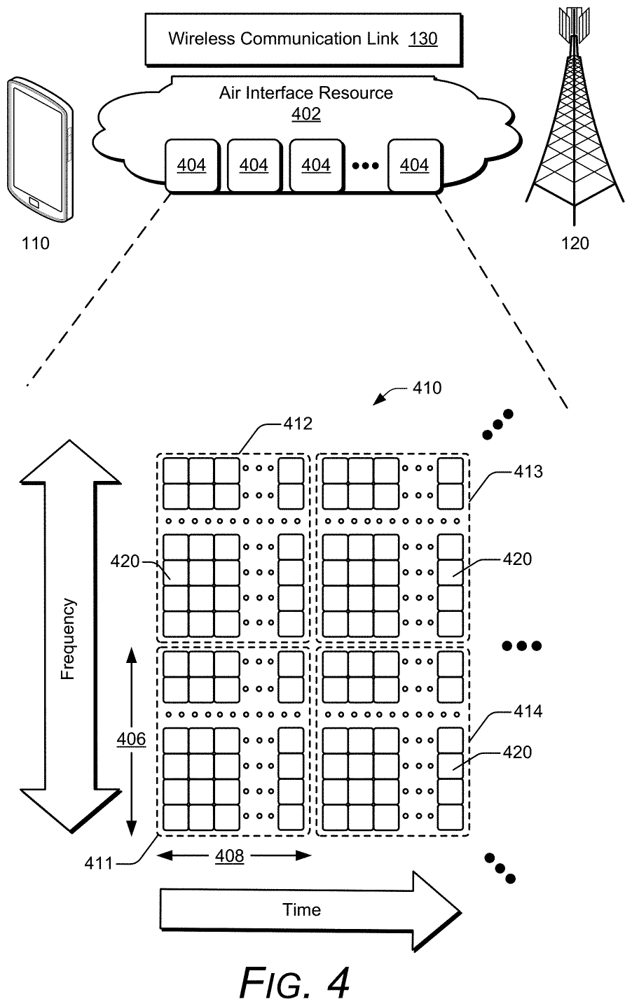

FIG. 4 illustrates an air interface resource that extends between a user equipment and a base station and with which various aspects of fast DRX cycle adjustment can be implemented. The air interface resource 402 can be divided into resource units 404, each of which occupies some intersection of frequency spectrum and elapsed time. A portion of the air interface resource 402 is illustrated graphically in a grid or matrix having multiple resource blocks 410, including example resource blocks 411, 412, 413, 414. An example of a resource unit 404 therefore includes at least one resource block 410. As shown, time is depicted along the horizontal dimension as the abscissa axis, and frequency is depicted along the vertical dimension as the ordinate axis. The air interface resource 402, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base stations 120 allocate portions (e.g., resource units 404) of the air interface resource 402 for uplink and downlink communications. Each resource block 410 of network access resources may be allocated to support respective wireless communication links 130 of multiple user equipment 110. In the lower left corner of the grid, the resource block 411 may span, as defined by a given communication protocol, a specified frequency range 406 and comprise multiple subcarriers or frequency sub-bands. The resource block 411 may include any suitable number of subcarriers (e.g., 12) that each correspond to a respective portion (e.g., 15 kHz) of the specified frequency range 406 (e.g., 180 kHz). The resource block 411 may also span, as defined by the given communication protocol, a specified time interval 408 or time slot (e.g., lasting approximately one-half millisecond or 7 orthogonal frequency-division multiplexing (OFDM) symbols). The time interval 408 includes subintervals that may each correspond to a symbol, such as an OFDM symbol. As shown in FIG. 4, each resource block 410 may include multiple resource elements 420 (REs) that correspond to, or are defined by, a subcarrier of the frequency range 406 and a subinterval (or symbol) of the time interval 408. Alternatively, a given resource element 420 may span more than one frequency subcarrier or symbol. Thus, a resource unit 404 may include at least one resource block 410, at least one resource element 420, and so forth.

In example implementations, multiple user equipment 110 (one of which is shown) are communicating with the base stations 120 (one of which is shown) through access provided by portions of the air interface resource 402. The resource manager 266 (shown in FIG. 2) may determine a respective DRX cycle configuration, PDCCH bandwidth, RRM measurement bandwidths, type of information, or amount of information (e.g., data or control information) to be communicated (e.g., transmitted) by the user equipment 110. For example, the resource manager 266 can determine that each user equipment 110 is to operate under a different respective DRX cycle configuration, PDCCH bandwidth, or RRM measurement bandwidth (e.g., based on an IDCR, as described herein), or transmit a different respective amount of information. The resource manager 266 then allocates one or more resource blocks 410 to each user equipment 110 based on the determined data rate or amount of information. The air interface resource 402 can also be used to transmit the IDCR, as described herein.

Additionally or in the alternative to block-level resource grants, the resource manager 266 may allocate resource units at an element-level. Thus, the resource manager 266 may allocate one or more resource elements 420 or individual subcarriers to different user equipment 110. By so doing, one resource block 410 can be allocated to facilitate network access for multiple user equipment 110. Accordingly, the resource manager 266 may allocate, at various granularities, one or up to all subcarriers or resource elements 420 of a resource block 410 to one user equipment 110 or divided across multiple user equipment 110, thereby enabling higher network utilization or increased spectrum efficiency. Additionally or alternatively, the resource manager 266 may, in response to the IDCR described herein, reallocate or change the allocation of air interface resources for a carrier, subcarrier, or carrier band.

The resource manager 266 can therefore allocate air interface resource 402 by resource unit 404, resource block 410, frequency carrier, time interval, resource element 420, frequency subcarrier, time subinterval, symbol, spreading code, some combination thereof, and so forth. Based on respective allocations of resource units 404, the resource manager 266 can transmit respective messages to the multiple user equipment 110 indicating the respective allocation of resource units 404 to each user equipment 110. Each message may enable a respective user equipment 110 to queue the information or configure the LTE transceiver 206, the 5G NR transceiver 208, or both to communicate using the allocated resource units 404 of the air interface resource 402.

Fast DRX Adjustment

In aspects, the user equipment 110 operates under a current DRX cycle configuration negotiated with, and provided by, the base station 121. The DRX cycle configuration includes a wake duration and a sleep duration. The wake duration is a time period during which the user equipment monitors downlink channels and physical layer signaling (e.g., paging messages). The sleep duration is a time period during which the user equipment can turn its receivers, RF front end, antenna circuitry, and other components off to save battery power. The DRX cycle configuration may be negotiated between the user equipment 110 and the base station 121 using any suitable control communication, such as Radio Resource Control (RRC) signaling, a Media Access Control (MAC) layer Control Element (CE), or a Physical Uplink Control Channel (PUCCH).

The user equipment 110 can detect a trigger event, such as a value of a thermal parameter or a battery-capacity parameter exceeding or falling below a threshold. In response to detecting the trigger event, the user equipment 110 can generate an instant DRX change request (IDCR), which includes a request to change the DRX cycle configuration (e.g., by extending the sleep duration) and transmit the IDCR to the base station 121. The user equipment 110 can transmit the IDCR using any of a variety of techniques. For example, the user equipment 110 can transmit the IDCR using a Random Access Channel (RACH) sequence or a Physical Random Access Channel (PRACH) sequence. Transmitting the IDCR using the random access message may be useful in lower mobility situations in which the user equipment is relatively stationary and communicating with or connecting to a particular base station or cell site.

In other cases, the user equipment 110 can transmit the IDCR using a tracking area update (TAU) message, or a radio access network notification area (RNA) update procedure. In particular, when the user equipment is mobile, different base stations in different cells may not always know where the user equipment is, and multiple base stations may send paging messages to the user equipment. The TAU message and the RNA update procedure are used by the user equipment to communicate with the base stations in the user equipment's tracking area or RNA to establish a connection with the proper base station. In this way, the IDCR is sent, not only to a single base station 121 (as with the RACH/PRACH sequence), but to multiple base stations. The TAU message is sent to the core network (e.g., the core network 150) and the RNA update is sent to all of the base stations in the radio access network (RAN) in which the user equipment is located. In either case (RACH/PRACH or TAU/RNA), the base station 121 receives the IDCR from the user equipment 110 and determines an adjusted DRX cycle configuration that is provided to the user equipment 110 using, for example, a Random Access Channel (RACH) response message. The user equipment can then operate under the adjusted DRX cycle configuration.

The base station 121 uses the IDCR to generate an adjusted DRX cycle configuration (e.g., by adjusting the current, negotiated DRX cycle configuration based at least in part on the IDCR). In addition to the request to change the DRX cycle configuration, the IDCR can include requests to change other DRX-related parameters, such as a PDCCH bandwidth, or an RRM measurement bandwidth. The request to change the DRX cycle configuration can take various forms. For example, the IDCR can include a request to change the DRX cycle configuration by setting a new value of the wake or sleep duration (e.g., to lengthen the sleep duration by changing it from 1.28 seconds to 10 seconds). Additionally or alternatively, the IDCR can include requests to change the DRX cycle configuration by multiplying the current value of the wake or sleep duration by a duration adjustment factor. For example, the duration adjustment factor can be a multiplier that lengthens (e.g., 1.25, 1.50, or 2.0) or shortens (e.g., 0.75, 0.50, or 0.25) the current sleep duration. Thus, an IDCR that includes a duration adjustment factor of 1.25 results in an adjusted DRX cycle configuration in which the sleep duration that is 25 percent longer than the current sleep duration. Similarly, an IDCR that includes a duration adjustment factor of 0.5 results in an adjusted DRX cycle configuration in which the sleep duration is half the length of the current sleep duration.

In some implementations, the user equipment 110 can transmit the IDCR to the base station 121 while the user equipment 110 is operating in a disengaged mode, as described above (e.g., the RRC-inactive mode or the RRC-idle mode). Further, the described techniques may be performed by the user equipment 110 and the base station 121 using applications or modules described herein, such as the DRX manager 220 and/or the resource manager 266, respectively.

In some implementations, user equipment 110 may transmit the IDCR to a second base station (e.g., the base station 122), which relays the IDCR to the base station 121. The base station 121 then provides the adjusted DRX cycle configuration to the user equipment 110. The base station 121 and the other base station 122 may be different or same types of base stations (e.g., a 5G NR base station or a 3GPP LTE base station) and may communicate using any suitable means, such as an Xn interface. Additionally or alternatively, the user equipment 110 may transmit the IDCR to the base station 121 using a first carrier and the base station 121 may provide the adjusted DRX cycle configuration using a second carrier.

Example Methods

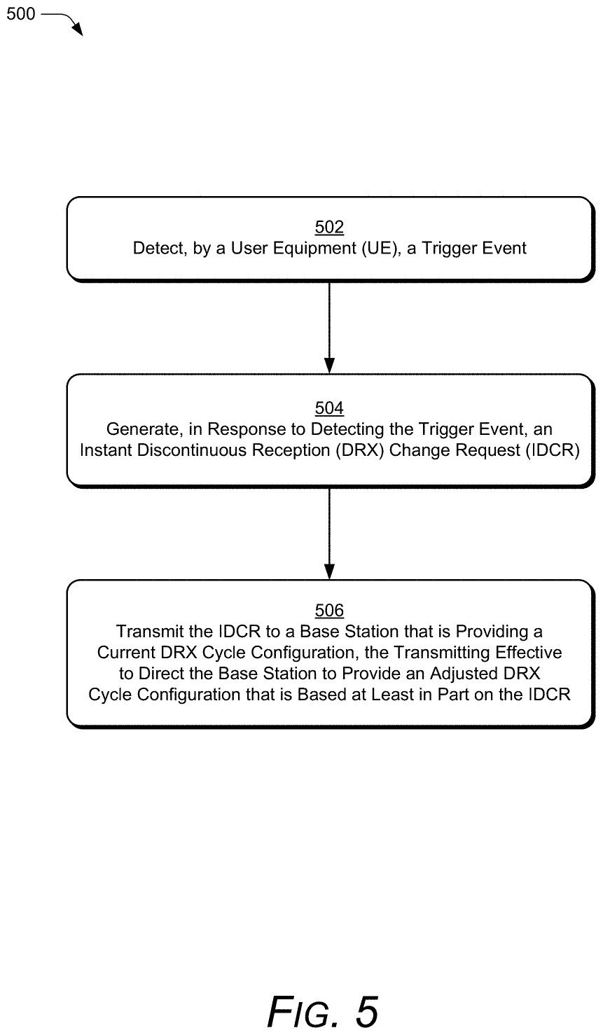

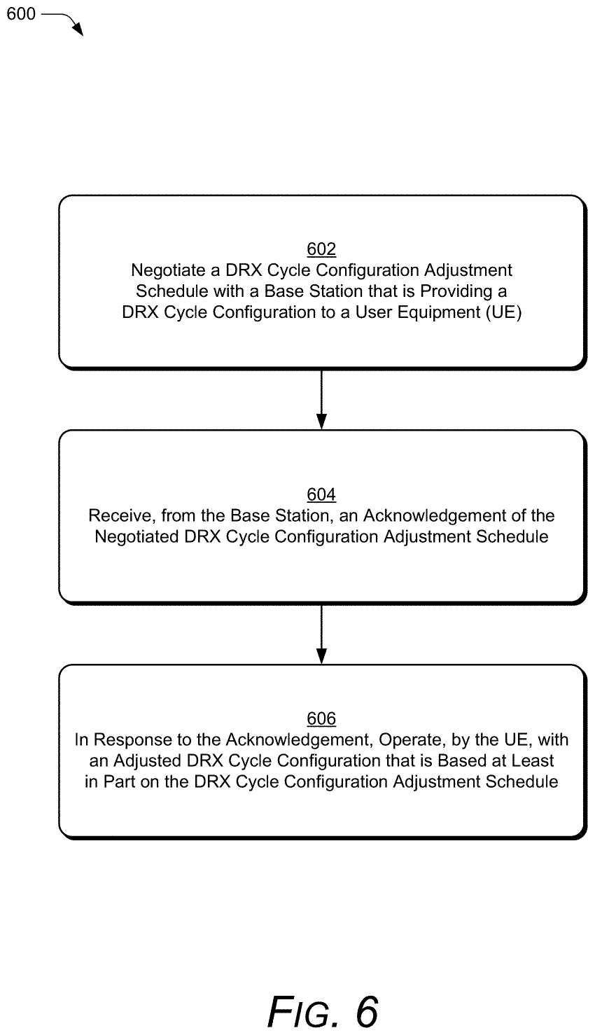

Example methods 500 and 600 are described with reference to FIGS. 5 and 6 in accordance with one or more aspects of fast DRX cycle adjustment. The order in which the method blocks are described are not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 for fast DRX cycle adjustment as generally related to adjusting a current DRX cycle configuration under which the user equipment is operating, that is negotiated between a user equipment and a base station. The adjustment is based at least in part on an instant DRX change request (IDCR) that is transmitted from the user equipment 110 to the base station 121 in response to an occurrence of a trigger event.

At block 502, the user equipment detects a trigger event. Generally, the trigger event indicates a condition or state of the user equipment that may be addressed by adjusting the DRX-related parameters such as the DRX cycle configuration. For example, the trigger event may be related to safety, performance, or power-consumption factors. In some cases, for example, the trigger event may occur when a thermal parameter of the user equipment 110 exceeds a thermal threshold, such as a particular temperature, a duration operating at a temperature above a safety threshold, or a percentage of a maximum safe operating temperature of the user equipment 110 (e.g., 90, 75, or 60 percent). Additionally or alternatively, the trigger event may occur if a remaining battery-capacity level falls below a capacity threshold. The threshold may be based on a percentage of battery capacity remaining (e.g., 40, 25, or 15 percent of battery capacity) or on an estimated or calculated duration of remaining battery life (e.g., 90, 60, or 30 minutes).

The user equipment 110 may detect the trigger event in any of a variety of manners. For example, the user equipment 110 may communicate with either or both of the thermal manager 216 and the power manager 218 to detect thermal-related or power-related trigger events. The trigger event may also be a weighted combination of various inputs (e.g., signals from the thermal manager 216 and the power manager 218 and potentially other elements in the user equipment 110 such as one or more of the transceivers 206, 208).

At block 504, in response to detecting the trigger event, the user equipment generates the IDCR. For example, when the user equipment 110 detects the trigger event (e.g., the battery capacity falls below the capacity threshold, or a temperature of the user equipment 110 exceeds the thermal threshold), the user equipment 110 generates an IDCR that can be implemented to mitigate the conditions that caused the occurrence of the trigger event. Generally, the IDCR is a request to change DRX-related services or parameters provided by the base station 121. More specifically, the IDCR may include a request to change any one or more of the DRX cycle configuration, a PDCCH bandwidth, or an RRM measurement bandwidth. As noted, the DRX cycle configuration includes a wake duration and a sleep duration, and the request to change the DRX cycle configuration may be a request to change the DRX cycle configuration by setting a new value of the sleep duration (e.g., to lengthen or shorten the sleep duration or the wake duration). In other cases, the request to change the DRX cycle configuration may be a request to multiply a current value of the sleep duration (or the wake duration) by a duration adjustment factor. The duration adjustment factor can be a multiplier that lengthens (e.g., 1.25, 1.50, or 2.0) or shortens (e.g., 0.75, 0.50, or 0.25) the current sleep or wake duration.

At block 506, the user equipment transmits the IDCR to the base station that is providing the current DRX cycle configuration, which directs the base station to provide an adjusted DRX cycle configuration that is based at least in part on the IDCR. For example, the user equipment 110 may transmit the IDCR to the base station 121, which is providing the current, negotiated DRX cycle configuration. In some implementations, the user equipment 110 transmits the IDCR to the base station 121 while the user equipment 110 is operating in a disengaged mode, as described above (e.g., the RRC-inactive mode or the RRC-idle mode). The user equipment 110 may transmit the IDCR in any suitable manner, such as using a random access message (e.g., a Random Access Channel (RACH) sequence or a Physical Random Access Channel (PRACH) sequence), or using an area update message (e.g., a tracking area update (TAU) message or a radio access network notification area (RNA) update procedure).

Transmitting the IDCR can direct the base station to provide an adjusted DRX cycle configuration that is based, at least in part, on the IDCR. For example, the base station 121 can provide an adjusted DRX cycle configuration to the user equipment 110 that is based, at least in part, on the IDCR transmitted by the user equipment 110. For example, the DRX cycle configuration may be adjusted by the duration adjustment factor requested in the IDCR. Alternatively, the base station may use the ICDR duration adjustment factor as a directional indication and either increase or decrease the DRX cycle configuration without necessarily reaching the duration adjustment factor specified in the ICDR. The user equipment 110 can then operate under the adjusted DRX cycle configuration. The base station 121 may provide the data rate using any suitable method, such as by a RACH response message. As noted, instead of or in addition to the request to change the DRX cycle configuration, the IDCR may include a request to change other DRX-related parameters or services. For example, the IDCR may include a request to change an amount of bandwidth provided by the base station 121, such as a PDCCH bandwidth or an RRM measurement bandwidth. In these cases, in response to the IDCR, the base station 121 can provide an adjusted PDCCH bandwidth, or an adjusted RRM measurement bandwidth, under which the user equipment 110 can operate.

The user equipment 110 may transmit the IDCR to the base station 121 using any of a variety of suitable techniques. For example, the user equipment 110 may transmit the IDCR to the master or serving base station using a wireless link, such as an LTE connection, a 5G NR connection, and so forth (e.g., using the wireless link 130). In other implementations, the user equipment 110 may transmit the IDCR to the master or serving base station using a second base station, using an inter-base station interface. In some implementations, the base station 121 that provides the adjusted DRX cycle configuration may be a 5G NR base station that includes an inter-base station interface 268, such as an Xn interface. The user equipment 110 may transmit the IDCR to the other base station (e.g., the other base station 122), which relays the IDCR to the base station 121. The base station 121 then provides the adjusted DRX cycle configuration to the user equipment 110. The Xn interface can allow the 5G NR base station 121 to receive the IDCR from the base station 122, which may be any suitable base station 120 (e.g., a second 5G NR base station or a 3GPP LTE base station).

Because the user equipment 110 typically uses less power when using a narrower-band connection (such as the connection to the LTE base station 120), this type of dual-connectivity implementation may be advantageous in a situation in which the trigger event occurs while the user equipment already has been granted uplink to the LTE base station. Further, in some implementations, the user equipment 110 may transmit the IDCR to the base station 121 using a particular carrier or sub-carrier and the base station 121 may provide the adjusted DRX cycle configuration on a same or different carrier or sub-carrier.

FIG. 6 illustrates another example method(s) 600 for fast DRX cycle adjustment as generally related to adjusting a current DRX cycle configuration, negotiated between a user equipment 110 and a base station 121, under which the user equipment is operating. The example method(s) 600 may be performed while the user equipment 110 is operating in a disengaged mode, as described above (e.g., the RRC-inactive mode or the RRC-idle mode).

At block 602, a user equipment negotiates a DRX cycle configuration adjustment schedule with a base station that is providing the current DRX cycle configuration. For example, the user equipment 110 negotiates the DRX cycle configuration adjustment schedule with the base station 121. In contrast to adjustments to the DRX cycle configuration that may be made while the user equipment 110 is in an engaged mode, such as the connected mode 312 described with reference to FIG. 3, the user equipment 110 can negotiate the DRX cycle configuration schedule while in a disengaged mode (e.g., as described with reference to FIG. 3), which may be entered into prior to the negotiation.

The UE can negotiate the DRX cycle configuration schedule (in the disengaged mode) using a random access message (e.g., a RACH sequence or a PRACH sequence), an update message (e.g., a TAU message, an RNA update procedure, or other techniques (e.g., RRC signaling, or a MAC control element). As described above, the DRX cycle configuration includes a wake duration and a sleep duration, and the user equipment 110 and the base station 121 may negotiate scheduled changes to the length of either or both the wake duration and the sleep duration. Further, the user equipment 110 and the base station 121 may negotiate scheduled changes to other DRX-related parameters, such as bandwidths that the base station 121 provides (e.g., the PDCCH bandwidth or the RRM measurement bandwidth).

At block 604, the user equipment may receive an acknowledgement of the negotiated DRX cycle configuration adjustment schedule from the base station. For example, the user equipment 110 may receive the acknowledgement of the negotiated DRX cycle configuration adjustment schedule from the base station 121.

At block 606, in response to the acknowledgement, the user equipment operates, under an adjusted DRX cycle configuration that is based at least in part on the DRX cycle configuration adjustment schedule. As described above, the DRX cycle configuration includes a wake duration and a sleep duration. The DRX cycle configuration adjustment schedule can be a series of adjustments to the sleep duration that are implemented at scheduled time intervals. The series of adjustments may be a predetermined series of adjustments in which each adjustment sets a new value of the sleep (and/or wake) duration. In some cases, the series of adjustments may be a predetermined series of adjustments in which each adjustment multiplies a current value of the sleep duration by a duration adjustment factor, as described above. In either case, the scheduled intervals in the series can be set as part of the DRX cycle configuration adjustment schedule and may be modified by the user equipment 110 or the base station 121. Further, the scheduled intervals may be of equal duration or of different durations, as negotiated between the user equipment 110 and the base station 121. Additionally or alternatively, the DRX cycle configuration adjustment schedule may include adjustments, similar to those described above, to other DRX-related parameters, such as bandwidths that the base station 121 provides (e.g., the PDCCH bandwidth or the RRM measurement bandwidth).

Although aspects of fast DRX cycle adjustment have been described in language specific to features and/or methods, the subject of the appended claims is not necessarily limited to the specific features or methods described. Rather, the specific features and methods are disclosed as example implementations of the fast DRX cycle adjustment, and other equivalent features and methods are intended to be within the scope of the appended claims. Further, various different aspects are described, and it is to be appreciated that each described aspect can be implemented independently or in connection with one or more other described aspects.

Several examples are described below.

Example 1: A method for adjusting a current discontinuous reception (DRX) cycle configuration for a user equipment (UE), comprising the UE: detecting a trigger event; in response to detecting the trigger event, generating an instant DRX change request (IDCR); and transmitting, while the UE is in a disengaged mode, the IDCR to a base station that is providing the current DRX cycle configuration, the transmitting effective to direct the base station to provide an adjusted DRX cycle configuration that is based at least in part on the IDCR.

Example 2: The method of example 1, wherein the disengaged mode is: a radio resource control (RRC)-Inactive mode; or an RRC-Idle mode.

Example 3: The method of example 1 or example 2, further comprising: transmitting the IDCR to the base station using a random access message.

Example 4: The method of example 3, wherein the random access message is a Random Access Channel (RACH) sequence or a Physical Random Access Channel (PRACH) sequence.

Example 5: The method of example 1 or example 2, further comprising: transmitting the IDCR to the base station using an area update message.

Example 6: The method of example 5, wherein the area update message is a tracking area update message or a radio access network notification area (RNA) update procedure.

Example 7: The method of any preceding example, wherein the IDCR includes a request to change one or more of: the current DRX cycle configuration; a physical downlink control channel bandwidth; or a radio resource management measurement bandwidth.

Example 8: The method of example 7, wherein: the current DRX cycle configuration includes a wake duration and a sleep duration; and the request to change the current DRX cycle configuration is a request to change the current DRX cycle configuration by: setting a new value of the sleep duration; or multiplying a current value of the sleep duration by a duration adjustment factor.

Example 9: The method of any preceding example, wherein the trigger event is one of: a remaining battery-capacity level falling below a capacity threshold; a value of a thermal parameter of the UE exceeding a thermal threshold; or a duration operating with a thermal parameter of the UE exceeding a thermal threshold.

Example 10: The method of any preceding example, wherein: transmitting the IDCR to the base station further comprises transmitting the IDCR to the base station using a first carrier; and the base station provides the adjusted DRX cycle configuration, based at least in part on the IDCR, using a second carrier.

Example 11: A method for adjusting a discontinuous reception (DRX) cycle configuration for a user equipment (UE), comprising the UE: entering a disengaged mode; negotiating a DRX cycle configuration adjustment schedule with a base station that is providing the DRX cycle configuration, the negotiating occurring while the UE is in the disengaged mode; receiving, from the base station, an acknowledgement of the negotiated DRX cycle configuration adjustment schedule; and in response to the acknowledgement, operating, by the UE, with an adjusted DRX cycle configuration that is based at least in part on the DRX cycle configuration adjustment schedule.

Example 12: The method of example 11, wherein the disengaged mode is: a radio resource control (RRC)-Inactive mode; or an RRC-Idle mode.

Example 13: The method of example 11 or example 12, wherein: the DRX cycle configuration includes a wake duration and a sleep duration; and the DRX cycle configuration adjustment schedule is a series of adjustments to the sleep duration, at scheduled time intervals, each adjustment comprising setting a new value of the sleep duration.

Example 14: The method of example 11 or example 12, wherein: the DRX cycle configuration includes a wake duration and a sleep duration; and the DRX cycle configuration adjustment schedule is a series of adjustments to the sleep duration, at scheduled time intervals, each adjustment comprising multiplying a current value of the sleep duration by a duration adjustment factor.

Example 15: A user equipment (UE), comprising: a radio frequency (RF) transceiver; and a processor and memory system configured to perform the method of any of the preceding examples.

Example 16: The example of any of examples 1-14, wherein negotiating the DRX cycle configuration adjustment schedule with a base station further comprises negotiating one or more of: the scheduled time intervals, the new value of the sleep duration, or a value of the duration adjustment factor.

Example 17: A user equipment (UE), comprising: a radio frequency (RF) transceiver; and a processor and memory system to implement a discontinuous reception (DRX) manager application configured to: detect a trigger event; generate, in response to the trigger event, an instant DRX change request (IDCR); transmit, using the RF transceiver, the IDCR to a base station that is providing a current DRX cycle configuration; receive, from the base station, an adjusted DRX cycle configuration that is based, at least in part, on the IDCR; and cause the UE to operate under the adjusted DRX cycle configuration.

Example 18: The UE of example 17, wherein transmitting the IDCR to the base station further comprises transmitting the IDCR to the base station while the UE is in a disengaged mode.

Example 19: The UE of example 18, wherein the disengaged mode is a radio resource control (RRC)-Inactive mode.

Example 20: The UE of example 18, wherein the disengaged mode is an RRC-Idle mode.

Example 21: The UE of example 17 or 18, wherein transmitting the IDCR to the base station further comprises transmitting the IDCR to the base station using a random access message.

Example 22: The UE of example 21, wherein the random access message is a Random Access Channel (RACH) sequence or a Physical Random Access Channel (PRACH) sequence.

Example 23: The UE of example 17 or 18, wherein transmitting the IDCR to the base station further comprises transmitting the IDCR to the base station using an area update message.

Example 24: The UE of example 23, wherein the area update message is a tracking area update message or a radio access network notification area (RNA) update procedure.

Example 25: The UE of any of examples 17-24, wherein the IDCR includes a request to change one or more of: a DRX cycle configuration; a physical downlink control channel bandwidth; or a radio resource management measurement bandwidth.

Example 26: The UE of example 25, wherein: the DRX cycle configuration includes a wake duration and a sleep duration; and the request to change the DRX cycle configuration is a request to change the DRX cycle configuration by: setting a new value of the sleep duration; or multiplying a current value of the sleep duration by a duration adjustment factor.

Example 27: The UE of any of examples 17-26, wherein: the base station is a first base station; and the DRX manager application is further configured to transmit the IDCR to the first base station by transmitting the IDCR to a second base station, effective to relay the IDCR to the first base station, the second base station being a 3rd Generation Partnership Project (3GPP) Long-Term Evolution (LTE) base station.

Example 28: A method for adjusting a current discontinuous reception (DRX) cycle configuration for a user equipment (UE), comprising: detecting, by the UE, a trigger event; in response to the trigger event, generating an instant DRX change request (IDCR); and transmitting the IDCR to a base station that is providing the current DRX cycle configuration, the transmitting effective to cause the base station to provide an adjusted DRX cycle configuration that is based at least in part on the IDCR.

Example 29: The method of example 28, wherein transmitting the IDCR to the base station further comprises transmitting the IDCR to the base station while the UE is in a disengaged mode.

Example 30: The method of example 29, wherein the disengaged mode is: a radio resource control (RRC)-Inactive mode; or an RRC-Idle mode.

Example 31: The method of example 29 or example 30, wherein transmitting the IDCR to the base station further comprises transmitting the IDCR to the base station via a random access message.

Example 32: The method of example 31, wherein the random access message is a RACH sequence or a PRACH sequence.

Example 33: The method of example 29 or 30, wherein transmitting the IDCR to the base station further comprises transmitting the IDCR to the base station via an area update message.

Example 34: The method of example 33, wherein the area update message is a tracking area update message or a radio access network notification area (RNA) update procedure.

Example 35: The method of example 28, wherein the IDCR includes a request to change one or more of: a DRX cycle configuration; a physical downlink control channel bandwidth; or a radio resource management measurement bandwidth.

Example 36: The method of example 35, wherein: the DRX cycle configuration includes a wake duration and a sleep duration; and the request to change the DRX cycle configuration is a request to change the DRX cycle configuration by: setting a new value of the sleep duration; or multiplying a current value of the sleep duration by a duration adjustment factor.

Example 37: The method of example 28, wherein the trigger event is: a remaining battery-capacity level falling below a capacity threshold; or a value of a thermal parameter of the UE exceeding a thermal threshold.

Example 38: The method of example 28, wherein: transmitting the IDCR to the base station further comprises transmitting the IDCR to the base station via a first carrier; and the base station to provides the adjusted DRX cycle configuration, based at least in part on the IDCR, via a second carrier.

1.-15. (canceled)

16. A method for adjusting a current discontinuous reception (DRX) cycle configuration for a user equipment (UE), comprising the UE:
detecting, while operating under the current DRX cycle configuration and in a disengaged mode, a trigger event;
based on detecting the trigger event, generating an instant DRX change request that requests a change to the current DRX cycle configuration; and
transmitting, while operating under the current DRX cycle configuration and in the disengaged mode, the instant DRX change request to a base station that is providing the current DRX cycle configuration using a random access message.

17. The method of claim 16, wherein the disengaged mode includes:
a radio resource control (RRC)-Inactive mode.

18. The method of claim 16, further comprising:
transmitting the instant DRX change request without waiting for an uplink grant.

19. The method of claim 16, wherein transmitting the instant DRX change request using the random access message further comprises:
transmitting the random access message as a Random Access Channel (RACH) sequence or a Physical Random Access Channel (PRACH) sequence.

20. The method of claim 16, wherein generating the instant DRX change request further comprises:
including, in the instant DRX change request, a request to change one or more of:
a physical downlink control channel bandwidth; or
a radio resource management measurement bandwidth.

21. The method of claim 16, wherein generating the instant DRX change request further comprises:
including, in the instant DRX change request, a request to change a wake duration and a sleep duration of the current DRX cycle configuration.

22. The method of claim 21, wherein generating the instant DRX change request further comprises:
requesting a series of adjustments to the wake duration and the sleep duration at a scheduled time interval, where each adjustment of the series of adjustment corresponds to a new value of the wake duration or the sleep duration.

23. The method of claim 16, wherein detecting the trigger event further comprises:
detecting one of:
a remaining battery-capacity level falling below a capacity threshold;
a value of a thermal parameter of the UE exceeding a thermal threshold; or
a duration operating with a thermal parameter of the UE exceeding a thermal threshold.

24. The method of claim 16, wherein transmitting the instant DRX change request to the base station further comprises:
transmitting the instant DRX change request to the base station using a first carrier, and
wherein the method further comprises:
using the adjusted DRX cycle configuration for a second carrier.

25. A method for adjusting a DRX cycle configuration for a UE, comprising the UE:
negotiating a first DRX cycle configuration with a base station;
entering a disengaged mode and operating in a DRX mode under the first DRX cycle configuration;
negotiating, while operating in the disengaged mode and in the DRX mode, a DRX cycle configuration adjustment schedule with the base station using at least one random access message;
receiving, from the base station, an acknowledgement of the negotiated DRX cycle configuration adjustment schedule; and
based on receiving the acknowledgement, operating in the DRX mode under a second DRX cycle configuration that is based at least in part on the DRX cycle configuration adjustment schedule.

26. The method of claim 25, wherein negotiating the DRX cycle configuration adjustment schedule with the base station further comprises:
negotiating the DRX cycle configuration adjustment schedule with the base station without waiting for an uplink grant.

27. The method of claim 25, wherein the first DRX cycle configuration includes a wake duration and a sleep duration, and
wherein negotiating the DRX cycle configuration adjustment schedule with the base station further comprises:
negotiating a change to the wake duration and the sleep duration.

28. The method of claim 27, wherein negotiating the change to the wake duration and the sleep duration further comprises:
negotiating a series of adjustments to the wake duration and the sleep duration at a scheduled time interval, where each adjustment of the series of adjustment corresponds to a new value of the wake duration or the sleep duration.

29. The method of claim 27, further comprising:
negotiating a change to one or more additional DRX cycle configuration parameters.

30. The method of claim 29, wherein negotiating the change to the one or more additional DRX cycle configuration parameters further comprises:
negotiating a change to one or more one or more of:
a physical downlink control channel bandwidth; or
a radio resource management measurement bandwidth.

31. The method of claim 25, wherein the disengaged mode includes:
an RRC-Inactive mode.

32. The method of claim 25, wherein negotiating the first DRX cycle configuration with the base station further comprises:
negotiating the first DRX cycle configuration with the base station using at least one control message.

33. A user equipment (UE) comprising:
an RF transceiver;
one or more processors; and
a memory system storing one or more processor executable instructions that, responsive to execution by the one or more processors, direct the user equipment to perform operations comprising:
detecting, while operating under a current discontinuous reception (DRX) cycle configuration and in a disengaged mode, a trigger event;
based on detecting the trigger event, generating an instant DRX change request that requests a change to the current DRX cycle configuration; and
transmitting, while operating under the current DRX cycle configuration and in the disengaged mode, the instant DRX change request to a base station that is providing the current DRX cycle configuration using a random access message.

34. The user equipment of claim 33, wherein the memory system stores additional processor executable instructions that, responsive to execution by the one or more processors, direct the user equipment to perform additional operations comprising:
generating the instant DRX change to request, as the change to the current DRX cycle configuration, a change to one or more one or more of:
a change to a wake duration of the current DRX cycle configuration;
a change to a sleep duration of the current DRX cycle configuration;
a physical downlink control channel bandwidth; or
a radio resource management measurement bandwidth.

35. The user equipment of claim 33, wherein the memory system stores additional processor executable instructions that, responsive to execution by the one or more processors, direct the user equipment to perform additional operations comprising:
transmitting the instant DRX change request to the base station without waiting for an uplink grant.
